(19) United States
(12) Patent Application Publication
(10) Pub. No.: US 2007/0233304 A1
(43) Pub. Date: Oct. 4, 2007

(54) INDUSTRIAL TRUCK WITH A DATA BUS AND A SECOND SENDING RECEIVING UNIT

(75) Inventors: Ralf Baginski, Neetze (DE); Frank Manken, Henstedt-Ulzburg (DE); Martin von Werder, Ammersbek (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Jungheinrich Aktiengesellschaft, Hamburg (DE)

(21) Appl. No.: 11/690,311

(22) Filed: Mar. 23, 2007

(30) Foreign Application Priority Data
Mar. 29, 2006 (DE) 10 2006 014 450.3

(51) Int. Cl. G06F 19/00

(52) U.S. Cl. 700/115

(57) ABSTRACT

An industrial truck with a data bus, to which several electronic units of the industrial truck are connected which send or receive telegrams via the data bus, and with a sending and receiving unit which can acquire data of a transponder present in the sending and receiving range of the sending and receiving unit, wherein the sending and receiving unit is connected to the data bus and analyses telegrams sent via the data bus and/or sends telegrams to the data bus.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

Modern industrial trucks have a multiplicity of electronic units. Among others, to these belong a driving control for controlling a drive motor, a lifting control for controlling the lifting function via a hydraulic system, an on-board computer and various control- and operating elements. In the operation, many of these units exchange data with each other, for instance, a control command of an operating element is forwarded to the driving control, or a condition information related to a lifting action is transmitted to the on-board computer by the lifting control.

For such communication processes, a vehicle data bus is normally provided, to which the electronic units are connected and communicate via so-called telegrams. A bus system frequently used in the industrial truck field is the so called CAN-Bus (Controller Area Network Bus).

A telegram sent to the data bus comprises a series of contents, for instance an address of a receiver, condition data or control commands, error codes, check numbers and so on. In principle, each telegram on the data bus is available for all the units connected to the data bus.

It is known to equip industrial trucks with a sending and receiving unit for automatic read-out of transponders. Such sending and receiving units, for instance RFID (Radio Frequency Identification) sending and receiving units, are applied in a diversity of fields and have normally standardised data interfaces for connection with a data processing unit, like USB (Universal Serial Bus) or RS232, for instance. In the context of industrial trucks, it is known to arrange a corresponding RFID sending and receiving unit on an industrial truck and to connect it with a separate materials management system or an on-board computer via the mentioned standard interfaces.

In this known arrangement, the sending and receiving unit continuously emits signals which activate assigned transponders, which are present in the sending and receiving range of the sending and receiving unit, so-called RFID tags in the example above, and prompt them to the emission of an encoded signal which is received by the sending and receiving unit. The continuous sending operation leads to a permanent emission of high-frequent radio frequency pulses in a limited frequency band, which can lead to problems at simultaneous operation of plural sending and receiving units in particular, for instance in a storeroom with many industrial trucks equipped in this way.

Departing from this, it is the objective of the present invention to provide an industrial truck which is equipped with a sending and receiving unit and which can use the latter in a more goal-directed and more versatile manner, in an environment with a multiplicity of further senders and receivers in particular. The present invention is also based on the objective to provide a method for the operation of this industrial truck, which permits an operation of a sending and receiving unit in an environment with a multiplicity of further sending and receiving units.

### BRIEF SUMMARY OF THE INVENTION

The industrial truck according to the present invention has a data bus, to which plural electronic units of the industrial truck are connected, which send or receive telegrams via the data bus, and a sending and receiving unit which can acquire data of a transponder present in the sending and receiving range of the sending and receiving unit, wherein the sending and receiving unit is connected to the data bus and analyses telegrams sent via the data bus and/or sends telegrams to the data bus.

The data bus may be a CAN bus for instance, via which the communication between the individual electronic units is handled. Transponders can be arranged at various positions in the operating range of the industrial truck. Wares to be transported as well as certain shelf positions, the bays of a high bay storage for instance, obstacles, signal installations, or other certain objects may be provided with a transponder. Data are stored in the transponder which serve for an unambiguous identification of the wares tagged by the transponder by means of a product code, for instance. The sending and receiving unit is capable to read out the data memorized in the transponder. In order to do this, at first an activating signal is emitted by the sending and receiving unit in the case of passive transponders, whereupon the transponder emits an encoded signal, which is received by the sending and receiving unit. It is essential for the present invention that the sending and receiving unit is connected with the data bus. Thus, a communication possibility between the sending and receiving unit and the other electronic units of the industrial truck has been created. In particular, it is provided that the sending and receiving unit analyses data sent via the data bus. Through this, all the data available on the data bus are in principle available for the sending and receiving unit. Through the possibility of the sending and receiving unit to analyse telegrams on the data bus, the sending and receiving unit can be controlled via the data bus in a very flexible manner.

By sending telegrams on the data bus, information from the sending and receiving unit, from the read-out transponders in particular, can be made available for all the electronic units connected to the data bus via the data bus. Through this, a manifold of new opportunities is provided to make use of this information in the operation of the industrial truck.

According to one embodiment, the sending and receiving unit has an interface for direct communication with the data bus. In principle, the sending and receiving unit can dispose about any arbitrary connection to the data bus, via a suitable adapter, for instance. However, the sending and receiving unit is advantageously equipped with an interface that can be directly connected with the data bus. In addition to the simplified construction achieved through this, the time-consuming and potentially error-prone transmission of the data via the standard interfaces and corresponding adapters can be omitted.

In one preferred embodiment, an analysing unit is provided, which analyses signals from the transponder received by the sending and receiving unit, and which is connected to the data bus. In principle, the analysing unit can be also integrated into the sending and receiving unit, however, through a separate analysing unit a modular construction is achieved, in which the sending and receiving unit is reduced to the elements essential for sending and receiving of the high frequency pulses, and the analysis of the received signals, a decoding for instance, is performed in the separate analysing unit. Both units are connected to the data bus independently from each other, so that even the information exchange between the two units can take place via the data bus.

According to one embodiment, the sending and receiving unit is a RFID sending and receiving unit. Through this, a technology current in many application fields is used for the sending and receiving unit.

In one preferred embodiment, the sending and receiving unit comprises a control module, which analyses telegrams sent via the data bus and which activates and deactivates the sending and receiving unit. The control module permits a simple activation and deactivation in accordance with the analysed telegrams.

In a further embodiment of the present invention, a load sensing system, which measures the loading condition of the load holding means, is connected to the data bus. Taken together with the sending and receiving unit connected to the data bus, control of the sending and receiving unit depending on the loading condition of the load holding means is made possible through this. For instance, the sending and receiving unit may be activated always when the load condition changes, i.e., when a load is picked up or set down, respectively. Even the detection of a fork occupancy may be provided as the trigger for activation.

The method according to the present invention for operating an industrial truck is distinguished through the fact that the sending and receiving unit is controlled in accordance with telegrams sent via the data bus. In this, control of the sending and receiving unit comprises all the interventions into the sending and receiving operation, an adjustment of the sending power for instance.

In one preferred embodiment of the method, the sending and receiving unit is activated and deactivated in accordance with telegrams sent via the data bus. Preferably, this activation and deactivation is performed depending on the travelling speed, by activating the sending and receiving unit upon falling below a first travelling speed and by deactivating it upon exceeding a second travelling speed, wherein the first travelling speed is smaller than or equal to the second travelling speed. Thus, unnecessary sending of the sending and receiving unit during rapid driving can be avoided. Only when falling below the first travelling speed, because the industrial truck is maneuvered slowly towards a load to be transported for instance, the sending and receiving unit is activated. In this case, the transponder to be read out is already in the proximity the vehicle.

Furthermore, it is preferably provided to activate and deactivate the sending and receiving unit depending on the position of the lifting mast or the load holding means. In addition or alternatively to the speed-dependent activation of the sending and receiving unit, additional data available on the data bus may be incorporated. For instance, this makes sense with a reach mast truck, in which activation of the sending and receiving unit can be performed when the reach mast is moved towards the front side. In this position of the reach mast, the load holding means approaches a load to be picked up or a storage position provided with a transponder.

Preferably, the sending and receiving unit can be activated and deactivated depending on a loading condition of the load holding means which is acquired by a load sensing system, always when the loading condition changes, for instance.

In a further preferred embodiment of the method according to the present invention, telegrams sent to the data bus by the sending and receiving unit act automatically upon the control system of the industrial truck. Supplementary to the provided control of the sending and receiving unit via the data bus, even another electronic unit of the industrial truck connected to the data bus can be controlled by the sending and receiving unit. For instance, through this it is made possible to stop the industrial truck without further intervention of the driver when it approaches an obstacle provided with a transponder. A suitable transponder can also be integrated into a stop sign, for instance, and may enforce automatic stopping of the industrial truck when the industrial truck approaches the stop sign. By such control interventions, an important contribution to traffic security can be made.

In one preferred embodiment, the travelling speed is limited depending on telegrams sent to the data bus by the sending and receiving unit. Such automatic limitation of the travelling speed can in turn take place as a reaction to corresponding traffic signs or possible dangerous situations, or even for the protection of particularly sensitive transportation goods, which are provided with a corresponding transponder.

According to a further embodiment of the method, the height of the load holding means or the maximum lifting or lowering speed is controlled depending on telegrams sent to the data bus by the sending and receiving unit. Through this, the smooth operation of the industrial truck can be facilitated for the driver, by driving automatically to the correct height of a storage location in accordance with a transponder provided on that storage location. In turn, a limitation of the lifting or lowering speed can make sense for the protection of particularly sensitive goods again, or also facilitate a precise movement towards certain storage locations.

According to a further embodiment, telegrams sent to the data bus by the sending and receiving unit are analysed and data contained therein are displayed on the display of an on-board computer, the on-board computer being connected to the data bus. In this realisation of the method, the connection of the sending and receiving unit with the data bus permits a particularly simple display of the data of a transponder read out by the sending and receiving unit, because these data are immediately available for the on-board computer for display, in the form of telegrams present on the data bus.

### BRIEF DESCRIPTION OF THE SEVERAL VIEWS OF THE DRAWINGS

The present invention is explained in the following by means of an example of its realisation, represented in two drawings.

FIG. 1 shows a schematic representation of the connection of the electronic components of an industrial truck according to the present invention,

FIG. 2 shows an illustration of the method according to the present invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

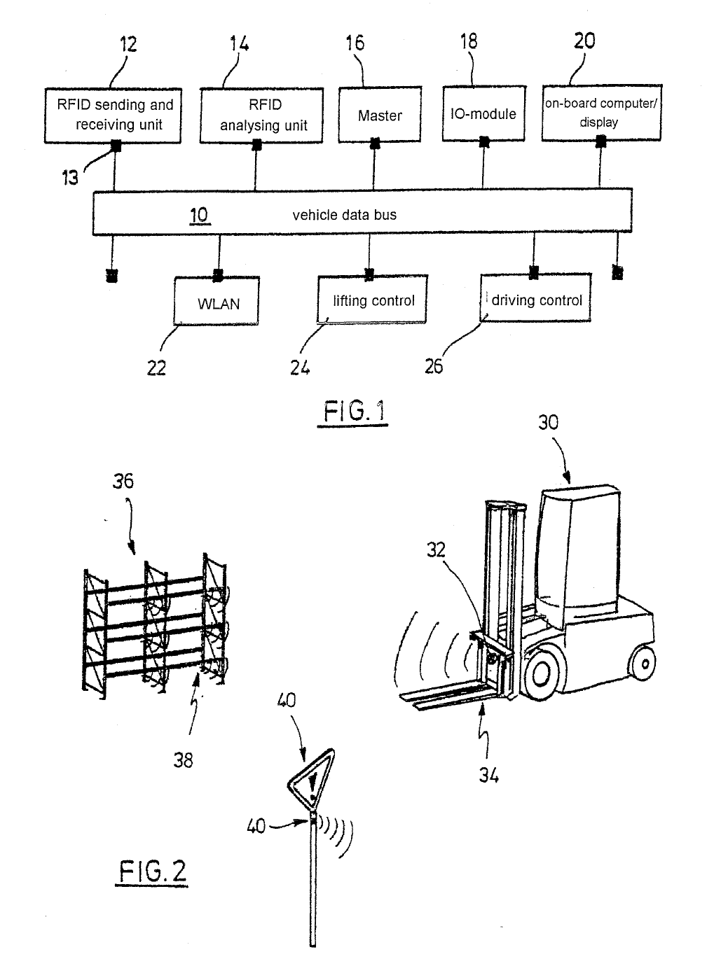

In FIG. 1, a vehicle data bus is represented at 10. It is dealt with a CAN-bus, via which all the electronic units connected to it can rapidly, simply and safely exchange data with each other. The data are sent in the form of telegrams via the data bus.

In the industrial truck according to the present invention, a RFID sending and receiving unit 12 is provided with a suitable interface 13, and the latter is directly connected to the vehicle data bus 10. The RFID sending and receiving unit 12 comprises a not shown antenna. Furthermore, in the shown example of realisation, a RFID analysing unit 14 is connected as a separate module to the vehicle data bus 10.

The RFID sending and receiving unit 12 converts the signals received from a transponder into a telegram and transmits them to the RFID analysing unit 14 via the vehicle data bus 10. The RFID analysing unit 14 receives the telegram and analyses the data contained therein, which were received from the transponder. In particular, the analysis comprises a decoding. Subsequently, the RFID analysing unit 14 sends a further telegram to the data bus 10, which contains the data received from the transponder in a processed form. In principle, these data are available for all the units connected to the data bus 10. To these belong the lifting control 24, the driving control 26 as well as the on-board computer 20 (onboard computer/display). The mentioned units can have direct access to the data of the transponder contained in the telegram. Alternatively, a central control unit 16 (master) can read the telegrams and forward additional telegrams on the data bus, which serve for controlling other units connected to the data bus.

For display purposes, telegrams sent by the sending and receiving unit 12 or the RFID analysing unit 14 can be also read and displayed immediately by an on-board computer 20 (on-board computer/display).

Furthermore, an IO-module 18 is connected to the data bus 10, which co-operates with a load sensing system provided on the load holding means in the present example of realisation. A loading condition measured by the not shown load sensing system is transformed into a corresponding telegram with the aid of the IO-module 18 and sent to the data bus. The loading condition reported by the IO-module 18, more accurately the corresponding telegram, can be received and analysed by the central control unit 16. When the central control unit 16 detects a change of the loading condition in doing so, it can send a further telegram to the data bus, which includes an activation command for the sending and receiving unit 12.

Furthermore, a WLAN unit 22 is connected to the vehicle data bus 10. This WLAN unit permits an integration of the industrial truck into an existing WLAN wireless network. As the case may be, the data read out from a transponder can be also sent via this wireless network.

The method according to the present invention is explained in more detail by means of FIG. 2. In FIG. 2, an industrial truck 30 is indicated, which is equipped with a RFID sending and receiving unit 32, which is disposed including its antenna near the load holding means 34. According to the present invention, the RFID sending and receiving unit is connected to the data bus of the industrial truck.

In the operation of the industrial truck, the sending and receiving unit 32 is activated and deactivated depending on the travelling speed. When falling below a first travelling speed, the sending and receiving unit 32 is activated. Through this, transponders present near the sending and receiving unit can be activated and read out. These are located on the wares to be transported, for instance, or also on a high rise rack 36, more precisely on each storage location of the high rise rack. For instance, there is a transponder at 38 in the undermost right side bay of the high rise rack 36. When the travelling speed of the industrial truck 30 falls below a first speed when approaching this storage location, the sending and receiving unit 32 is activated and the data memorized in the transponder 38 are read out. For instance, when after picking up a charge from the corresponding storage location, the industrial truck 30 moves away from the rack 36 and in doing so the travelling speed exceeds a second speed, the sending and receiving unit 32 is deactivated again. Thus, unnecessary sending operation is avoided, and as the case may be, the radio channel of the sending and receiving unit 32 can be utilised otherwise in this period of time.

A warning sign 40, equipped with a RFIF transponder 42, is also indicated in FIG. 2. When the sending and receiving unit 32 of the industrial truck 32 reaches the sending range of the warning sign 40, the data of the transponder 42 are made available via the data bus of the industrial truck 30. Subsequently, the electronic control system of the industrial truck automatically limits the maximum possible travelling speed.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. An industrial truck with a data bus, to which several electronic units of the industrial truck are connected which send or receive telegrams via the data bus, and with a sending and receiving unit which can acquire data of a transponder present in the sending and receiving range of the sending and receiving unit, characterised in that the sending and receiving unit is connected to the data bus and analyses telegrams sent via the data bus and/or sends telegrams to the data bus.

2. An industrial truck according to claim 1, characterised in that the sending and receiving unit has an interface for direct connection with the data bus.

3. An industrial truck according to claim 1, characterised in that an analysing unit is provided, which analyses signals from the transponder received by the sending and receiving unit, and which is connected to the data bus.

4. An industrial truck according to claim 1, characterised in that the sending and receiving unit is a RFID sending and receiving unit.

5. An industrial truck according to claim 1, characterised in that the sending and receiving unit comprises a control module which analyses telegrams sent via the data bus and which activates and deactivates the sending and receiving unit.

6. An industrial truck according to claim 1, characterised in that a load sensing system, which measures the loading condition of the load holding means, is connected to the data bus.

7. A method to operate an industrial truck according to claim 1, wherein the sending and receiving unit is controlled in accordance with telegrams sent via the data bus.

8. A method according to claim 7, wherein the sending and receiving unit is activated and deactivated in accordance with telegrams sent via the data bus.

9. A method according to claim 7, wherein the sending and receiving unit is activated upon falling below a first travelling speed and deactivated upon exceeding a second travelling speed, wherein the first travelling speed is smaller than or equal to the second travelling speed.

10. A method according to claim 7, wherein the sending and receiving unit is activated and deactivated depending on the position of the lifting mast or of the load holding means.

11. A method according to claim 7, wherein the sending and receiving unit is activated and deactivated depending on a loading condition of the load holding means which is acquired by a load sensing system.

12. A method according to claim 7, wherein telegrams sent to the data bus by the sending and receiving unit act automatically upon the control system of the industrial truck.

13. A method according to claim 12, wherein the travelling speed is limited depending on telegrams sent to the data bus by the sending and receiving unit.

14. A method according to claim 12, wherein the height of the load holding means or the maximum lifting or lowering speed is controlled depending on telegrams sent to the data bus by the sending and receiving unit.

15. A method according to claim 7, wherein telegrams sent to the data bus by the sending and receiving unit are analysed and data contained therein are displayed on the display of an on-board computer, the on-board computer being connected to the data bus.
